(19) United States
(12) Patent Application Publication
(10) Pub. No.: US 2024/0354833 A1
(43) Pub. Date: Oct. 24, 2024

(54) BEHAVIOR PREDICTING DEVICE

(71) Applicant: NTT DOCOMO, INC., Tokyo (JP)

(72) Inventors: Kazuki KINJOU, Chiyoda-ku (JP); Hiroto AKATSUKA, Chiyoda-ku (JP); Masayuki TERADA, Chiyoda-ku (JP); Motoko SUZUKI, Chiyoda-ku (JP); Takako KOMINATO, Chiyoda-ku (JP)

(73) Assignee: NTT DOCOMO, INC., Tokyo (JP)

(21) Appl. No.: 18/688,513

(22) PCT Filed: Aug. 22, 2022
(86) PCT No.: PCT/JP2022/031590

§ 371 Date: Mar. 1, 2024

(30) Foreign Application Priority Data
Sep. 30, 2021 (JP) 2021-160671

(51) Int. Cl. G06Q 30/0601

(52) U.S. Cl. CPC G06Q 30/0639

(57) ABSTRACT

A population involved in actions in the movement destination area is predicted. A purchase predicting device 1 includes: a storage unit 10 that stores a prediction coefficient, which is a probability that a person in a predetermined area will be involved in actions, and an average moving population ratio, which is a probability that a person in a predetermined area will move to a movement destination area that is an area of a movement destination; an acquisition unit 11 that acquires population distribution data regarding a population for each area; and a prediction unit 13 that predicts a population involved in purchasing for each movement destination area based on the population distribution data acquired by the acquisition unit 11 and the prediction coefficient and the average moving population ratio stored in the storage unit 10.

### TECHNICAL FIELD

One aspect of the present disclosure relates to an action predicting device that predicts a population involved in actions.

### BACKGROUND ART

Patent Literature 1 below discloses a retail store management system that predicts the sales volume of each product from the prediction of the number of visitors based on causal information.

### CITATION LIST

### Patent Literature

Patent Literature 1: Japanese Unexamined Patent Publication No. 2002-24350

### SUMMARY OF INVENTION

### Technical Problem

In the above-described retail store management system, it is not possible to predict the number of people who will purchase products among people in the movement destination area, which is an area to which people will move. Therefore, it is desirable to predict a population involved in actions (for example, purchasing products) in the movement destination area.

### Solution to Problem

An action predicting device according to one aspect of the present disclosure includes: a storage unit that stores an action probability, which is a probability that a person in a predetermined area is going to be involved in actions, and a movement probability, which is a probability that a person in a predetermined area is going to move to a movement destination area that is an area of a movement destination; an acquisition unit that acquires population distribution data regarding a population for each area; and a prediction unit that predicts a population involved in actions for each movement destination area based on the population distribution data acquired by the acquisition unit and the action probability and the movement probability stored in the storage unit.

According to this aspect, a population involved in actions for each movement destination area is predicted based on the population distribution data, the action probability, and the movement probability. That is, it is possible to predict the population involved in actions in the movement destination area.

### Advantageous Effects of Invention

According to one aspect of the present disclosure, it is possible to predict a population involved in actions in the movement destination area.

### BRIEF DESCRIPTION OF DRAWINGS

FIG. 1 A schematic diagram showing a usage image of a purchase predicting device according to an embodiment.

FIG. 2 A schematic diagram showing an example of the effects of the purchase predicting device according to the embodiment.

FIG. 3 A diagram showing an example of the system configuration of a purchase prediction system including the purchase predicting device according to the embodiment.

FIG. 4 A diagram showing an example of a table of population distribution data.

FIG. 5 A diagram showing an example of a table of moving population data.

FIG. 6 A diagram showing an example of a table of weather data.

FIG. 7 A diagram showing an example of a table of purchase quantity data.

FIG. 8 A diagram showing an example of the functional configuration of the purchase predicting device according to the embodiment.

FIG. 9 A diagram showing an example of training data.

FIG. 10 A diagram showing an example (part 1) of a table of population distribution data including a prediction coefficient.

FIG. 11 A diagram showing an example (part 2) of a table of population distribution data including a prediction coefficient.

FIG. 12 A diagram showing an example of prediction of the number of purchases using a prediction model.

FIG. 13 A diagram showing an example of a table of moving population data including an average moving population and an average moving population ratio.

FIG. 14 A diagram showing an example of a table of population distribution data used to calculate a purchase probability.

FIG. 15 A diagram showing an example of a table of purchasing population data.

FIG. 16 A diagram showing an example of a table of purchasing population data including a purchase probability.

FIG. 17 A diagram showing an example of sending a customer.

FIG. 18 A flowchart (part 1) showing an example of processing performed by the purchase prediction system.

FIG. 19 A flowchart (part 2) showing an example of processing executed by the purchase prediction system.

FIG. 20 A flowchart showing an example of processing performed by the purchase predicting device according to the embodiment.

FIG. 21 A diagram showing an example of the hardware configuration of a computer used in the purchase predicting device according to the embodiment.

### DESCRIPTION OF EMBODIMENTS

Hereinafter, embodiments of the present disclosure will be

described in detail with reference to the diagrams. In addition, in the description of the diagrams, the same elements are denoted by the same reference numerals, and repeated description thereof will be omitted. In addition, the embodiments of the present disclosure in the following description are specific examples of the present invention, and the present invention is not limited to these embodiments unless there is a statement that specifically limits the present invention.

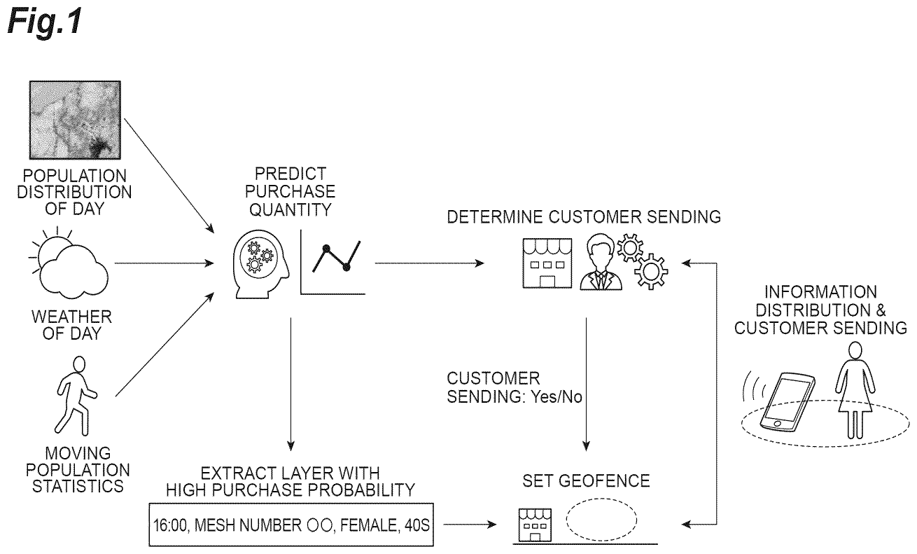

FIG. 1 is a schematic diagram (part 1) showing a usage image of a purchase predicting device 1 (action predicting device) according to an embodiment. The purchase predicting device 1 is a server device that predicts the number of purchases by customers and extracts segments (gender, age, and place of residence) with a high probability of purchase among customers, for each product (for example, food) or service at the store (retail store), and encourages customers to visit the store and purchase products or services based on the predicted number of purchases and the extracted customer segments.

Hereinafter, in the present embodiment, “products or services” will be collectively referred to as “products”. In addition, in the present embodiment, for the convenience of explanation, processing relevant to a specific (one already determined) store (simply referred to as a “store” in the present embodiment) rather than any store will be described. For example, by appropriately using a store ID, which is store identification information, during processing, it is possible to extend the processing relevant to any store.

As shown in FIG. 1, the purchase predicting device 1 predicts the number of purchases by customers based on the population distribution of the day, the weather of the day, and movement demographics that are statistics on the movement of people. Then, the purchase predicting device 1 extracts a group with a high purchase probability. More specifically, the purchase predicting device 1 extracts (picks up) mesh (area) segments that have a high correlation with the number of future purchases used for prediction. For example, it is assumed that “16:00, mesh number ◯◯, female, 40s” is extracted. Then, the purchase predicting device 1 determines whether to send customers based on the predicted number of purchases. More specifically, it is automatically determined whether or not to send customers based on the customer sending conditions set in advance by the manager (person in charge) of the store. When it is determined that customers will be sent, a geofence is set (created) around the mesh/segment with high correlation. When a customer checks in to the set geofence, the purchase predicting device 1 sends information to the customer to send the customer to the store. For example, coupons will be distributed to women in their 40s who enter the vicinity of mesh number ◯◯ at 16:00 to encourage the women to visit and make purchases.

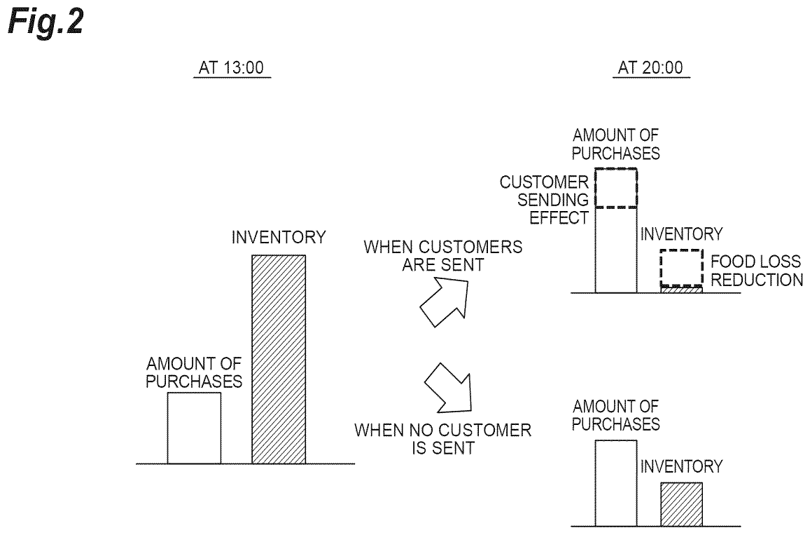

FIG. 2 is a schematic diagram showing an example of the effects of the purchase predicting device 1 according to the embodiment. The left side in FIG. 2 is a graph showing the amount of customer purchases and (amount of) store inventory at 13:00. The upper right side in FIG. 2 is a graph showing the amount of purchases and inventory at 20:00 (on the same day) when the purchase predicting device 1 sends customers. As shown in the graph, inventory decreases as the amount of purchases increases due to the customer sending effect of the purchase predicting device 1. When the product is food, food loss can be reduced by reducing inventory. On the other hand, the lower right side in FIG. 2 is a graph showing the amount of purchases and inventory at 20:00 (on the same day) when the purchase predicting device I does not send customers. As shown in the graph, since there is no customer sending effect, the amount of purchases does not increase and inventory (food loss) occurs.

In general, the amount of food loss by domestic businesses (restaurants, supermarkets, and the like) is approximately 3.52 million tons, which is a loss of opportunity. Since discarded food is incinerated at garbage disposal sites, there is a problem that a large amount of food loss leads to an increase in carbon dioxide emissions. For example, according to the purchase predicting device 1, food loss can be reduced by sending customers on days when the probability of food loss is high.

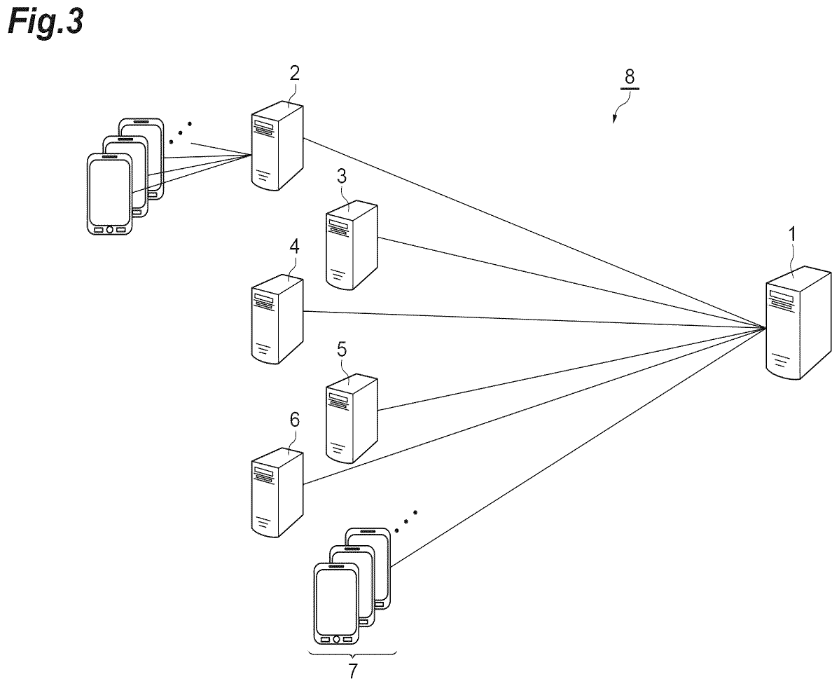

FIG. 3 is a diagram showing an example of the system configuration of a purchase prediction system 8 including the purchase predicting device 1 according to the embodiment. As shown in FIG. 3, the purchase prediction system 8 includes the purchase predicting device 1, a population distribution data acquisition device 2, a moving population data acquisition device 3, an external data acquisition device 4, a purchasing inventory management device 5, a store manager device 6, and a customer smartphone 7. The purchase predicting device 1, the population distribution data acquisition device 2, the moving population data acquisition device 3, the external data acquisition device 4, the purchasing inventory management device 5, the store manager device 6, and the customer smartphone 7 are communicably connected to each other through a network, such as the Internet, so that information can be transmitted and received therebetween.

The population distribution data acquisition device 2 is a server device that acquires population distribution data regarding the population distribution around (near, close to, in the vicinity of, within a predetermined distance) the store and transmits the population distribution data to the purchase predicting device 1. The information or the like regarding the store may be stored in the population distribution data acquisition device 2 in advance, or may be transmitted and acquired in advance from the purchase predicting device 1. Without being limited to the population distribution data acquisition device 2, the information or the like regarding the store targeted in the present embodiment may be stored in advance in various devices, or may be transmitted and acquired in advance from the purchase predicting device 1 or the like.

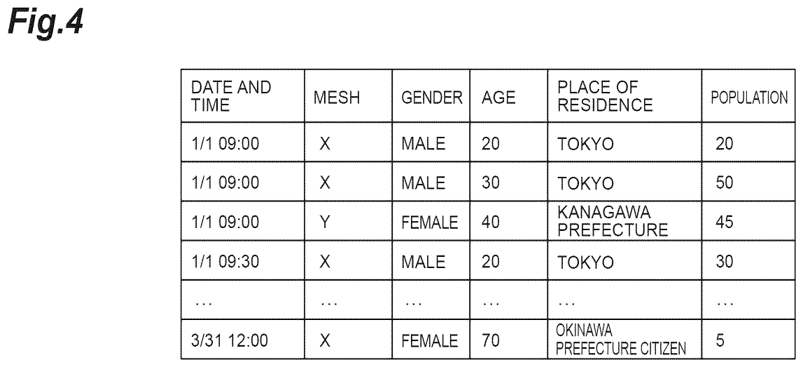

FIG. 4 is a diagram showing an example of a table of population distribution data. As shown in FIG. 4, in the population distribution data, a date and time, a mesh indicating the position, range, or area, a person's gender, a person's age, a person's place of residence, and a population that is the number of people of the gender, age, and place of residence who are present in the mesh at the date and time are associated with each other. The population distribution data shown in FIG. 4 indicates, for example, population distribution data around the store. In this case, the store is located around a mesh X and a mesh Y (including the inside of the mesh X or the inside of the mesh Y) shown in FIG. 4.

The population distribution data acquisition device 2 may acquire population distribution data based on terminal information collected from a mobile terminal that is a mobile terminal capable of performing mobile communication and carried by each person and that can measure its own location using a GPS (Global Positioning System). When collecting the terminal information, for example, known techniques such as Mobile Spatial Statistics (registered trademark) provided by NTT DOCOMO, INC. are used. The population distribution data acquisition device 2 may acquire population distribution data in real time and transmit the population distribution data to the purchase predicting device 1.

The moving population data acquisition device 3 is a server device that acquires moving population data related to moving population statistics and transmits the moving population data to the purchase predicting device 1. For example, the moving population data acquisition device 3 may acquire moving population data based on the population distribution data acquired by the population distribution data acquisition device 2. Although the detailed explanation will be given later, the moving population data includes a movement source mesh (may be simply referred to as a “mesh”), which is a mesh from which people move, and a movement destination mesh that is a mesh of a movement destination (may be referred to as a “movement mesh”), which is a mesh to which people move. The moving population data acquisition device 3 acquires moving population data in which the movement source mesh is around the store, and transmits the moving population data to the purchase predicting device 1. The purchase predicting device 1 may acquire moving population data and transmit the moving population data to the purchase predicting device 1 once a month.

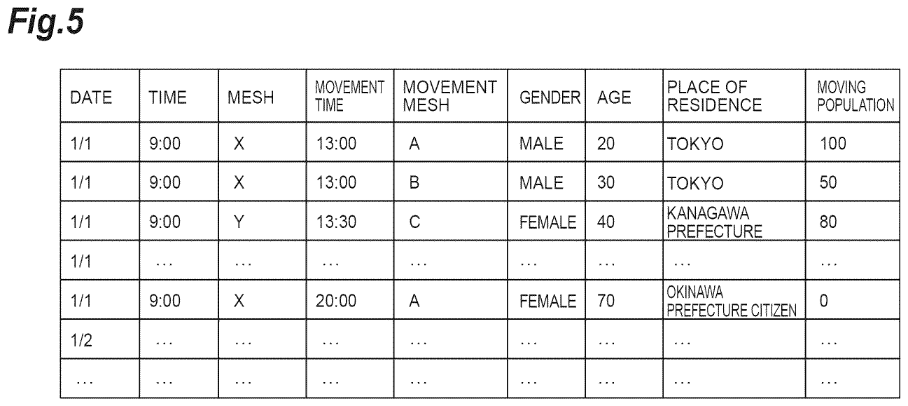

FIG. 5 is a diagram showing an example of a table of moving population data. As shown in FIG. 5, in the moving population data, a date when a person starts moving, a time when a person starts moving, a mesh from which a person moves when the person starts moving, a movement time that is a time when the person arrives at the movement mesh that is a mesh to which the person moves, a movement mesh, a person's gender, a person's age, a person's place of residence, and a moving population that is the number of people of the gender, age, and place of residence who start moving from the mesh on the date and time and arrive at the movement mesh at the movement time are associated with each other. The moving population data shown in FIG. 5 indicates, for example, moving population data around the store. In this case, the store is located around the mesh X and the mesh Y (including inside the mesh X or inside the mesh Y) shown in FIG. 5. The moving population data is used from the perspective of which meshes people go to, using the mesh (within a predetermined range around the store) included in the prediction as a movement source.

The external data acquisition device 4 is a server device that acquires external data, which is data acquired from an external device or the like, and transmits the external data to the purchase predicting device 1. The external data includes weather data regarding the weather around the store. For example, the external data acquisition device 4 may acquire external data from other various devices through a network. The external data acquisition device 4 may acquire external data in real time and transmit the external data to the purchase predicting device 1.

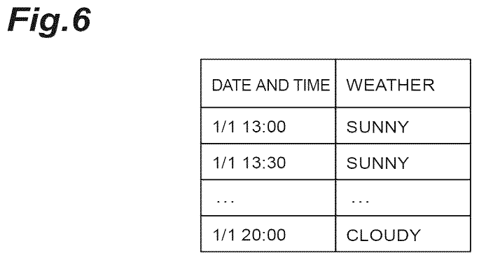

FIG. 6 is a diagram showing an example of a table of weather data. As shown in FIG. 6, in the weather data, the date and time and (information indicating) the weather at the date and time are associated with each other. The weather data shown in FIG. 6 indicates, for example, weather data around the store. When the weather data is data related to future weather, weather based on weather forecast (predicted weather) is used as the weather instead of actual weather.

The purchasing inventory management device 5 is a server device that acquires purchase quantity data regarding the number of purchases by customers of the store's products and stock quantity data regarding the number of products in stock at the store, and transmits the purchase quantity data and the stock quantity data to the purchase predicting device 1. The purchasing inventory management device 5 is, for example, a POS (Point of Sale) system. The purchasing inventory management device 5 may acquire purchase quantity data in real time and transmit the purchase quantity data to the purchase predicting device 1, or may acquire stock quantity data in real time and transmit the stock quantity data to the purchase predicting device 1.

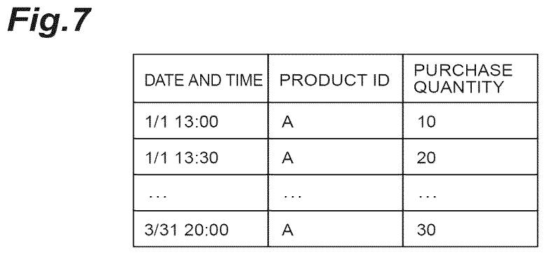

FIG. 7 is a diagram showing an example of a table of purchase quantity data. As shown in FIG. 7, in the purchase quantity data, a date and time, a product ID that is product identification information, and the sales volume of the product indicated by the product ID at the date and time are associated with each other. The purchase quantity data shown in FIG. 7 indicates, for example, purchase quantity data of the store.

Although not shown, the stock quantity data includes, for example, a time, a product ID, an expiration date of the product (for example, food) indicated by the product ID, and the number of products in stock indicated by the product ID at the time are associated with each other.

The store manager device 6 is a server device that acquires customer sending conditions data regarding customer sending conditions, which are conditions for sending customers, and distribution information, which is information to be distributed to customers, and transmits the customer sending conditions data and the distribution information to the purchase predicting device 1. The store manager device 6 is a device operated by a store manager. The store manager inputs the customer sending conditions data and the distribution information into the purchase predicting device 1. The store manager device 6 may be realized as a Web application.

Although not shown, in the customer sending conditions data, for example, a time, a product ID, a stock quantity, the predicted number of purchases that is the number of purchases predicted (by a prediction unit 13 described later), and the expiration date of the product indicated by the product ID are associated with each other.

Although not shown, in the distribution information, for example, a product ID and information (advertisement and the like) of the product indicated by the product ID are associated with each other.

The customer smartphone 7 is a smartphone carried by (one or more) customers at the store. In the present embodiment, a plurality of customers are collectively referred to as a customer, and a plurality of customer smartphones 7 are collectively referred to as a customer smartphone 7. The customer smartphone 7 includes a GPS, and can measure its own location. The customer smartphone 7 transmits location attribute information including its own location information, customer attribute information, and the like to the purchase predicting device 1 in order to determine check-in to the geofence. The customer smartphone 7 receives distribution information transmitted from the purchase predicting device 1 to send customers, and displays the distribution information on the customer smartphone 7.

Although not shown, in the location attribute information, for example, a customer ID that is customer identification information, a time, the location (latitude and longitude and the like) of the customer smartphone 7 at the time, the gender of the customer indicated by the customer ID, the age of the customer indicated by the customer ID, and the place of residence of the customer indicated by the customer ID are associated with each other.

The above explanation has been given on the assumption that the data necessary for the processing of the purchase predicting device 1 is prepared in advance on each device side of the population distribution data acquisition device 2, the moving population data acquisition device 3, the external data acquisition device 4, the purchasing inventory management device 5, the store manager device 6, and the customer smartphone 7, but the present invention is not limited to this. For example, the data necessary for the processing of the purchase predicting device 1 may be prepared in such a manner that each of the population distribution data acquisition device 2, the moving population data acquisition device 3, the external data acquisition device 4, the purchasing inventory management device 5, the store manager device 6, and the customer smartphone 7 transmits raw data of all stores, rather than data related to a specific store, to the purchase predicting device 1 and store-related data is extracted from the raw data on the purchase predicting device 1 side.

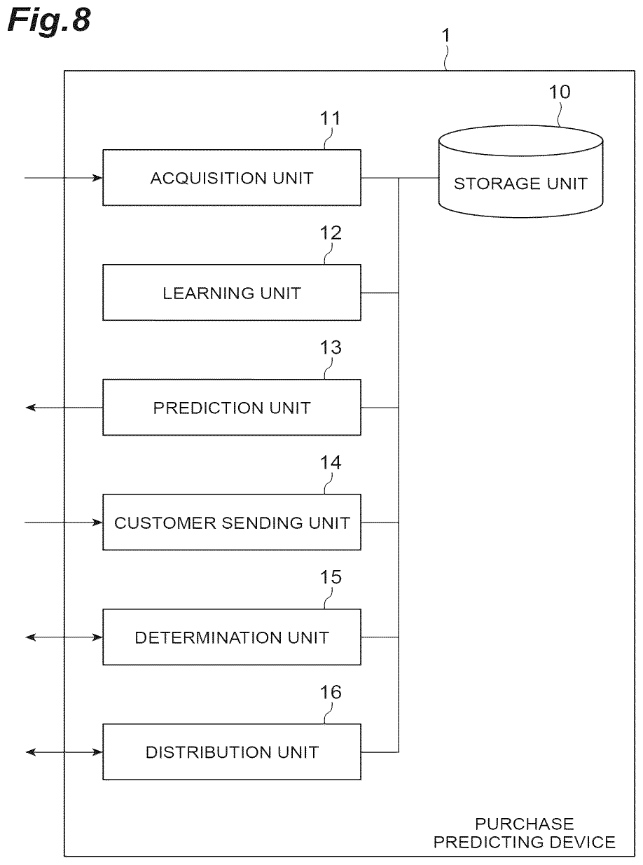

FIG. 8 is a diagram showing an example of the functional configuration of the purchase predicting device 1 according to the embodiment. As shown in FIG. 8, the purchase predicting device 1 includes a storage unit 10 (storage unit), an acquisition unit 11 (acquisition unit), a learning unit 12, a prediction unit 13 (prediction unit), a customer sending unit 14 (guiding unit), a determination unit 15 (guiding unit), and a distribution unit 16 (guiding unit).

Each functional block of the purchase predicting device 1 is assumed to function within the purchase predicting device 1, but the present invention is not limited to this. For example, some of the functional blocks of the purchase predicting device 1 may function within a computer device, which is a computer device different from the purchase predicting device 1 and is connected to the purchase predicting device 1 through a network, while appropriately transmitting and receiving information to and from the purchase predicting device 1. For example, the customer sending unit 14 may be realized by a customer sending determination device that is a different device. The determination unit 15 may be realized by a check-in determination device that is a different device. The distribution unit 16 may be realized by an information distribution device that is a different device. In addition, some of the functional blocks of the purchase predicting device 1 may be omitted, a plurality of functional blocks may be integrated into one functional block, or one functional block may be separated into a plurality of functional blocks.

Hereinafter, each function of the purchase predicting device 1 shown in FIG. 8 will be described.

The storage unit 10 stores any information used for calculations in the purchase predicting device 1, calculation results of the purchase predicting device 1, and the like. The information stored in the storage unit 10 may be referenced by each function of the purchase predicting device 1 as appropriate.

The storage unit 10 stores a prediction coefficient (action probability), which is a probability that a person in a predetermined mesh (area) will be involved in purchasing (actions), and an average moving population ratio (movement probability), which is a probability that a person in a predetermined mesh will move to the movement mesh that is a mesh of a movement destination (movement destination area). The action may be purchasing a product or service at the store. Although the present embodiment is based on the assumption that purchasing is an example of action, the present invention is not limited to this. Details of the prediction coefficient and the average moving population ratio will be described later.

The acquisition unit 11 acquires information from its own device (purchase predicting device 1) or another device through the network. The acquisition unit 11 may cause the storage unit 10 to store the acquired information, or may output the acquired information to another functional block.

The acquisition unit 11 acquires population distribution data regarding the population for each mesh (area) from the population distribution data acquisition device 2 or the like. The population of the population distribution data may be further determined for each time. That is, the acquisition unit 11 acquires population distribution data regarding the population for each time and each mesh. The population of the population distribution data may be further determined for each attribute of a person. That is, the acquisition unit 11 may acquire population distribution data regarding the population for each mesh and each attribute of a person, or may acquire population distribution data regarding the population for each time, each mesh, and each attribute of a person.

The acquisition unit 11 may acquire moving population data from the moving population data acquisition device 3 or the like. The acquisition unit 11 may acquire weather data from the external data acquisition device 4 or the like. The acquisition unit 11 may acquire purchase quantity data and stock quantity data from the purchasing inventory management device 5 or the like. The acquisition unit 11 may acquire customer sending conditions data and distribution information from the store manager device 6 or the like. The acquisition unit 11 may acquire location attribute information from the customer smartphone 7 or the like.

The learning unit 12 generates a prediction model that predicts the future number of purchases based on past data (population distribution data, purchase quantity data, and external data) stored (accumulated) by the storage unit 10. The learning unit 12 causes the storage unit 10 to store the generated prediction model.

The prediction model is a combination of a computer program and parameters. In addition, the prediction model is a combination of the structure of a neural network and a parameter (weighting coefficient) that is the strength of the connection between neurons in the neural network. In addition, the prediction model is a combination of instructions for a computer to obtain a single result (execute predetermined processing), that is, a computer program that causes the computer to function.

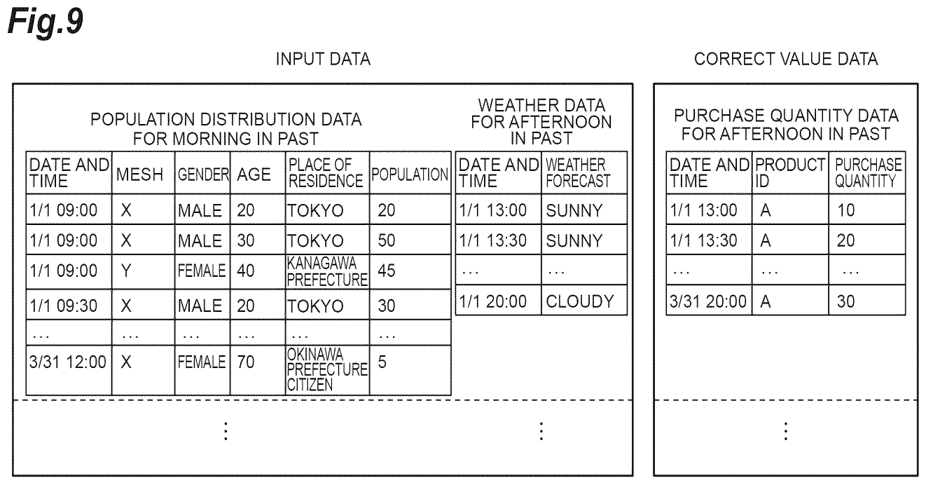

The learning unit 12 may generate a prediction model by performing learning based on training data including sets of input data and correct value data. For example, the learning unit 12 generates a prediction model by performing learning based on training data including sets of (input data including) population distribution data (regarding the population distribution around the store) for the morning of a certain day in the past and weather data for the afternoon of the day (around the store) and (correct value data including) purchase quantity data (of the store) for the afternoon of the day. FIG. 9 is a diagram showing an example of training data. In the training data shown in FIG. 9, a set of population distribution data for the morning of January 1st and weather data for the afternoon of the same day (January 1st) and correct value data for the afternoon of the same day (January 1st) are shown (in practice, the training data includes a plurality of sets for January 2nd, January 3rd, and the like).

By performing learning based on the training data shown in FIG. 9, for example, the learning unit 12 learns a relationship with respect to the number of purchases (or purchase quantity data) for the afternoon of the day (at the store) from the population distribution data (regarding the population distribution around the store) for the morning of a certain day and the weather data (around the store) for the afternoon of the day. By performing learning based on the training data shown in FIG. 9, for example, the learning unit 12 generates a prediction model that outputs the number of purchases (or purchase quantity data) for the afternoon of a certain day (at the store) from the population distribution data (regarding the population distribution around the store) for the morning of the day and the weather data (around the store) for the afternoon of the day. That is, the generated prediction model predicts the number of future purchases.

The prediction coefficient generated by the learning of the learning unit 12 will be described. For example, through the learning of the learning unit 12, the relationship between the population distribution in the morning and the weather in the afternoon and the number of purchases in the afternoon is learned, and the prediction coefficient is optimized for each product, time, and weather. The number of purchases is expressed by the following equation, for example.

Number of purchases=(population_{date and time, mesh, gender, age, place of residence}×prediction coefficient_{date and time, mesh, gender, age, place of residence})

The prediction coefficient is an existing technique in machine learning. For the prediction coefficient, for example, the site at the following URI, that explains Elastic-Net in the open source machine learning library scikit-learn can be referred to.

https://www.tutorialspoint.com/scikit_learn/scikit_learn_elastic_net.htm

Decision tree algorithms (Random Forest, XGBoost, and the like) can also calculate the degree of contribution to prediction for each feature quantity. Therefore, it is expected to be used in the same manner as the prediction coefficient. However, the prediction coefficient is not limited to the contents of these specific existing techniques.

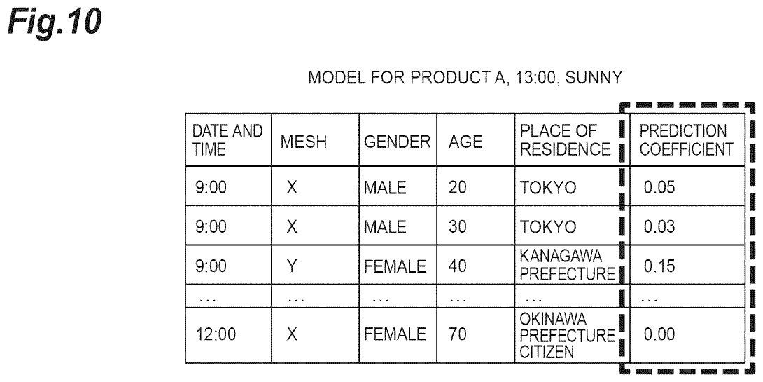

FIG. 10 is a diagram showing an example (part 1) of a table of population distribution data including a prediction coefficient. The prediction coefficient in the table example shown in FIG. 10 indicates the probability (degree) of people (population distribution) contributing to the purchase of product “product A” at time “13:00” when the weather is “sunny”. For example, the first record of the table example in FIG. 10 indicates that, for a person who is in the mesh “mesh X” at time “9:00” and whose gender is “male”, age is “20s”, and place of residence is “Tokyo”, the probability of purchasing the product “product A” at time “13:00” (on the same day) when the weather is “sunny” is “0.05” (5%).

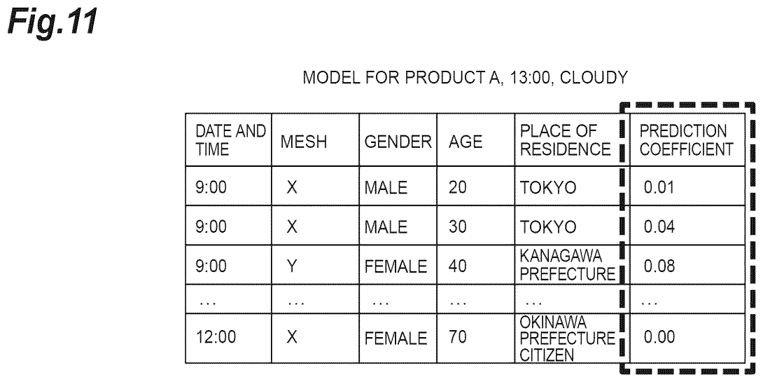

FIG. 11 is a diagram showing an example (part 2) of a table of population distribution data including a prediction coefficient. The difference from the table example shown in FIG. 10 is that the weather is “cloudy” instead of “sunny”, and the prediction coefficient differs accordingly.

The learning unit 12 causes the storage unit 10 to store the prediction coefficient (or population distribution data including the prediction coefficient) generated by learning.

The prediction unit 13 predicts the number of purchases (in the future) at the store based on the prediction model stored in the storage unit 10. More specifically, by applying to the prediction model the population distribution data (regarding the population distribution around the store) for the morning of a certain day (for example, today) and the weather data (around the store) for the afternoon of the day, the prediction unit 13 acquires the number of purchases (or purchase quantity data) for the afternoon of the day (at the store) that is output from the prediction model, and uses this as a prediction result. The prediction unit 13 causes the storage unit 10 to store the predicted number of purchases (or purchase quantity data).

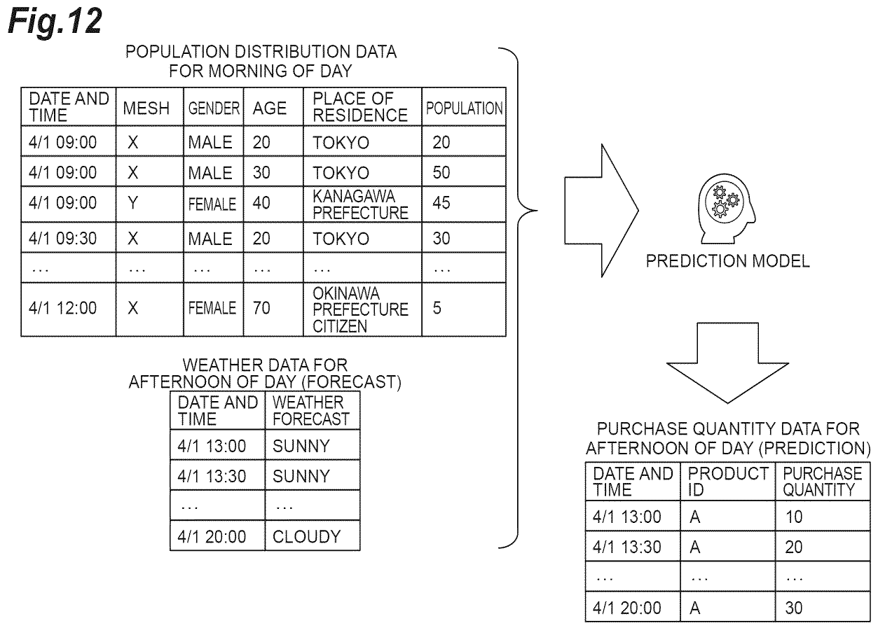

FIG. 12 is a diagram illustrating an example of prediction of the number of purchases using a prediction model. FIG. 12 shows a scene in which purchase quantity data (of the store) for the afternoon of the day (April 1st) is predicted by applying to the prediction model the population distribution data (regarding the population distribution around the store) for the morning of the day and the weather data (forecast) (around the store) for the afternoon of the day.

The prediction unit 13 calculates the purchase probability (for each time of the afternoon, each mesh, each gender, each age, and each place of residence) based on the prediction coefficient stored in the storage unit 10 and the moving population data acquired by the acquisition unit 11. A specific calculation method will be described below.

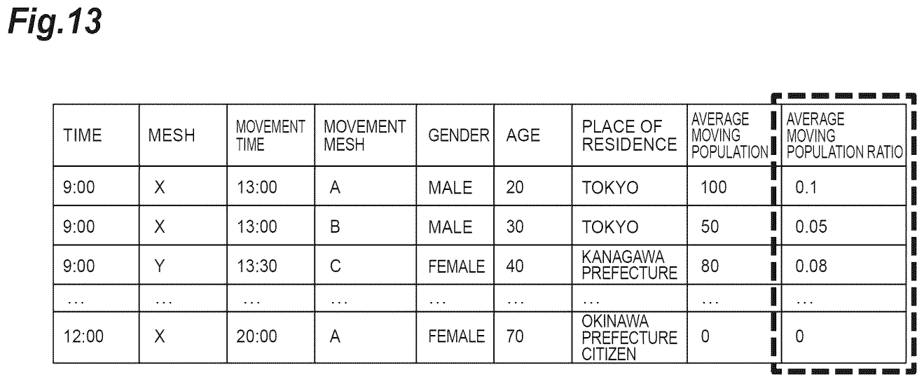

The prediction unit 13 calculates an average moving population ratio based on the moving population data acquired by the acquisition unit 11. The average moving population ratio is a ratio (probability) indicating where the population is typically likely to move from each mesh. The prediction unit 13 may calculate the average population movement from any mesh in the morning to any mesh in the afternoon based on the moving population data. The prediction unit 13 calculates data obtained by summing up the moving population data (date, time, mesh, movement time, movement mesh, gender, age, place of residence, and moving population) with respect to time as an average moving population, and calculates an average moving population ratio by dividing the average moving population of each record (row) by the total number of average moving populations at the corresponding time (“1000” in a table example shown in FIG. 13 described later). FIG. 13 is a diagram showing an example of a table of moving population data including the average moving population and the average moving population ratio. The prediction unit 13 causes the storage unit 10 to store the calculated moving population ratio.

The prediction unit 13 predicts a population involved in purchasing (actions) for each movement destination mesh based on the population distribution data acquired by the acquisition unit 11 and the prediction coefficient (action probability) and the average moving population ratio (movement probability) stored in the storage unit 10.

The prediction coefficient may be a probability that a person in a predetermined mesh at a predetermined time will be involved in purchasing (actions). The average moving population ratio may be a probability that a person in a predetermined mesh at a predetermined time will move to the movement destination mesh.

The prediction coefficient may be a probability for each attribute of a person. The average moving population ratio may be a probability for each attribute of a person. The prediction unit 13 may predict a population involved in purchasing (actions) for each movement destination mesh and each attribute of a person.

The prediction coefficient may be a probability for each weather. The prediction unit 13 may make predictions further based on the weather data acquired by the acquisition unit 11.

The prediction unit 13 may further predict a probability that a person will be involved in purchasing (actions) based on the predicted population involved in purchasing (actions).

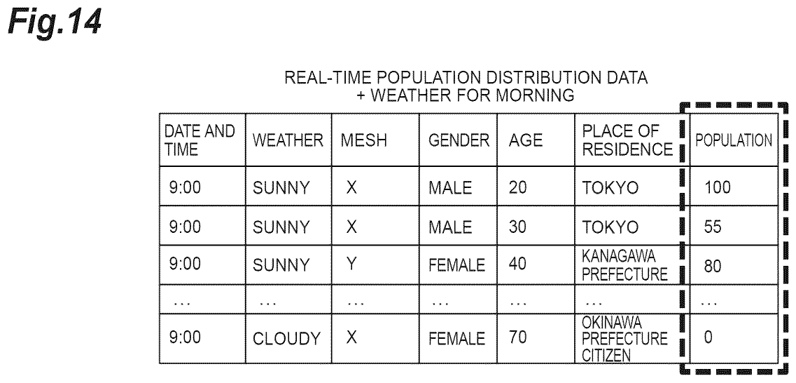

Hereinafter, the detailed explanation will be given with reference to FIGS. 14, 15, and 16 in addition to FIGS. 10 and 13 described above.

FIG. 14 is a diagram showing an example of a table of population distribution data used to calculate purchase probability. The table example shown in FIG. 14 is a table in which morning (real-time) population distribution data and weather (forecast) for the afternoon of the day are combined.

The prediction unit 13 associates the model of the table example shown in FIG. 10 that matches the morning time and the afternoon weather of the same day in the table example shown in FIG. 14 and multiplies a population for each morning time, each mesh, and each attribute in the table example shown in FIG. 14 by the prediction coefficient for each morning time, each mesh, and each attribute in the table example shown in FIG. 10, thereby calculating the purchasing population for each morning time and each attribute. Then, the prediction unit 13 multiplies an average moving population ratio in the example table shown in FIG. 13, which has each morning time (time before movement), each movement source mesh, and each attribute corresponding to the calculated purchasing population for each morning time, mesh, and attribute, and adds up the results for each afternoon time (time after movement), each movement destination mesh, and each attribute, thereby calculating the purchasing population in the afternoon. The prediction unit 13 causes the storage unit 10 to store the calculated purchasing population.

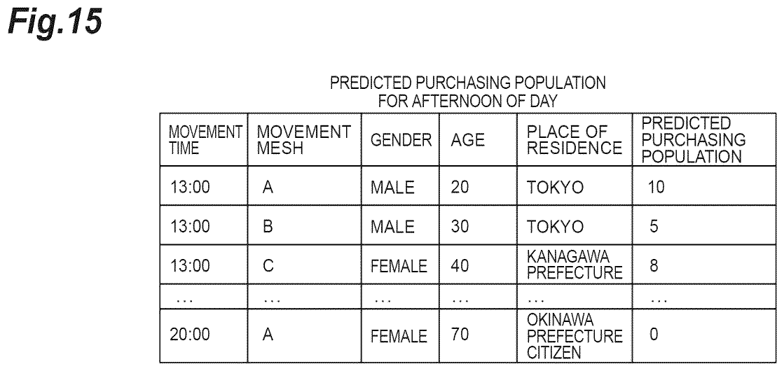

FIG. 15 is a diagram showing an example of a table of purchasing population data. As shown in FIG. 15, in the purchasing population data, a movement time, a movement mesh, the gender of a person who moved, the age of a person who moved, the place of residence of a person who moved, and a predicted purchasing population that is the purchasing population calculated by the prediction unit 13 are associated with each other.

The prediction unit 13 calculates a purchase probability by dividing the calculated purchasing population for each afternoon time, each movement destination mesh, and each attribute by the total value of the purchasing population for each time. That is, the prediction unit 13 converts the purchasing population into a ratio to obtain a purchase probability for each movement time, movement mesh, gender, age, and place of residence. The prediction unit 13 causes the storage unit 10 to store the calculated purchase probability.

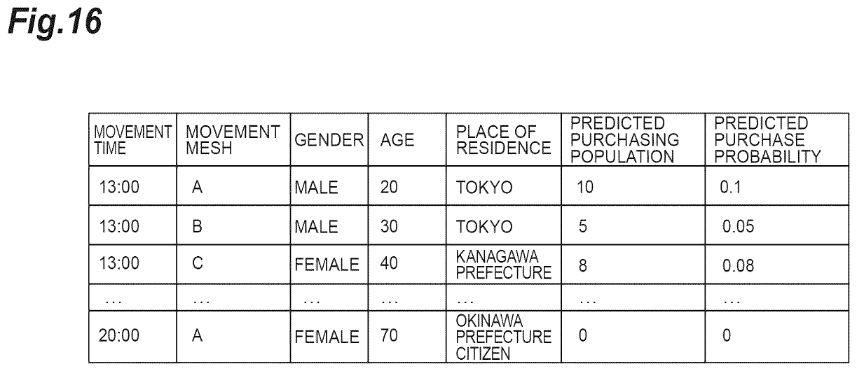

FIG. 16 is a diagram showing an example of a table of purchasing population data including a purchase probability. As shown in FIG. 16, a predicted purchase probability, which is the purchase probability calculated by the prediction unit 13, is further associated.

The customer sending unit 14 determines customer sending based on the customer sending conditions registered in advance by using the predicted number of purchases and the stock quantity for each product and time. For example, the customer sending unit 14 may determine customer sending based on (at least one or more of) the stock quantity data acquired from the purchasing inventory management device 5, the customer sending conditions data acquired from the store manager device 6, the predicted number of purchases (in which the time, the product ID, and the number of purchases are associated with each other), and a predicted purchase probability value (in which the time, the product ID, the gender, the age, the place of residence, the location, and the purchase probability are associated with each other). For example, the customer sending unit 14 determines to send customers when the difference between the stock quantity and the predicted number of purchases for the product A with the expiration date of the day is “100” at “18:00”.

When the customer sending unit 14 determines to send customers, targets (gender, age, place of residence, location, and the like) with a high purchase probability are selected for each time and product by using the predicted purchase probability value. The customer sending unit 14 outputs the selection result to the determination unit 15 as customer sending target information. In the customer sending target information, for example, a time, a product ID, the gender of a target, the age of a target, the place of residence of a target, and the location of a target are associated with each other.

The determination unit 15 registers a geofence based on the customer sending target information received from the customer sending unit 14, and performs a check-in determination. The determination unit 15 transmits geofence registration information to the customer smartphone 7 when registering the geofence. In the geofence registration information, for example, a time, a period during which the geofence is set, the gender of a target, the age of a target, the place of residence of a target, the location of a target, and the range of the geofence are associated with each other.

After registering the geofence, the determination unit 15 acquires location attribute information from the customer smartphone 7 based on the geofence registration information, and performs a check-in determination regarding whether or not the customer has checked in to the geofence based on the acquired location attribute information. The determination unit 15 outputs the determination result of the check-in determination to the distribution unit 16 as check-in determination information. In the check-in determination information, for example, a customer ID, which is identification information of a customer who checked in, and a product ID included in the customer sending target information are associated with each other.

The distribution unit 16 transmits customer distribution information to the customer smartphone 7 based on the check-in determination information received from the determination unit 15 and the distribution information acquired from the store manager device 6. In the customer distribution information, for example, a customer ID included in the check-in determination information and product information (advertisement and the like) included in the distribution information are associated with each other.

The customer views the product information acquired and displayed by the customer smartphone 7, and heads to the corresponding store if the customer likes the product.

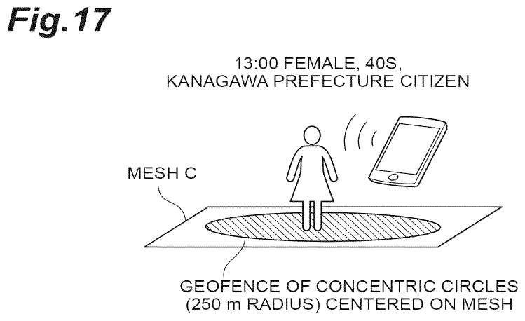

FIG. 17 is a diagram showing an example of sending a customer. In FIG. 17, it is assumed that the third record in the table example of purchasing population data shown in FIG. 16 is selected as a target by the customer sending unit 14. In FIG. 17, the determination unit 15 registers a geofence (a geofence of concentric circles (250 m radius) centered on the mesh C) for customers whose gender is “female”, age is “40s”, and place of residence is “Kanagawa Prefecture” at the movement time “13:00” (the time may be “13:00 to 13:59”) in the movement mesh “mesh C” (movement destination area).

As described above, the customer sending unit 14, the determination unit 15, and the distribution unit 16 guide people based on the prediction result of the prediction unit 13. More specifically, the customer sending unit 14, the determination unit 15, and the distribution unit 16 set geofences for segments with high purchase probabilities at each time, and encourage sending customers through information distribution. The customer sending unit 14, the determination unit 15, and the distribution unit 16 may guide people in the movement destination mesh. The guide may be sending customers to the store.

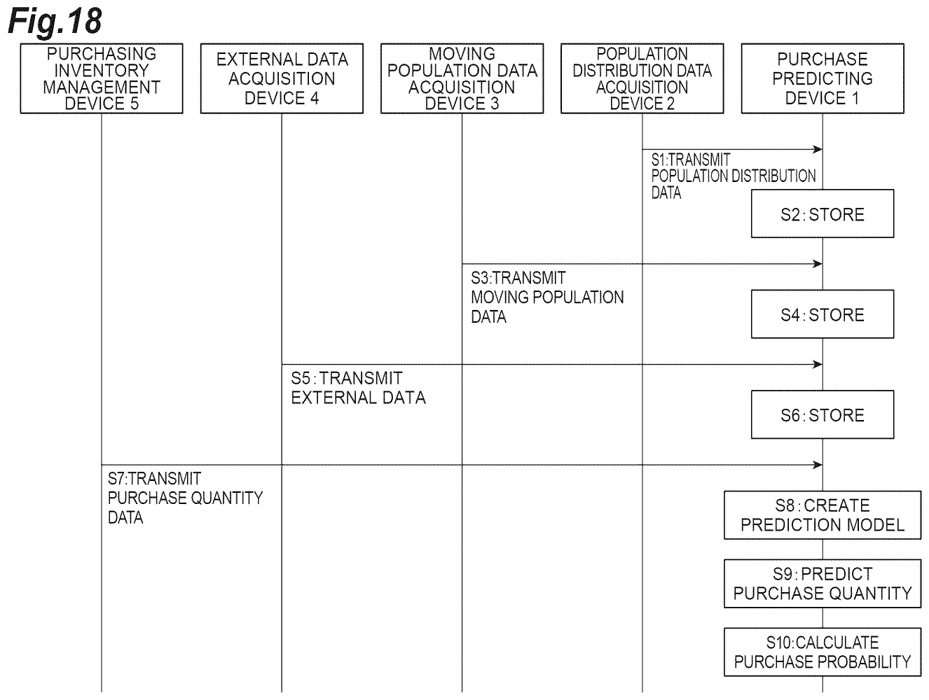

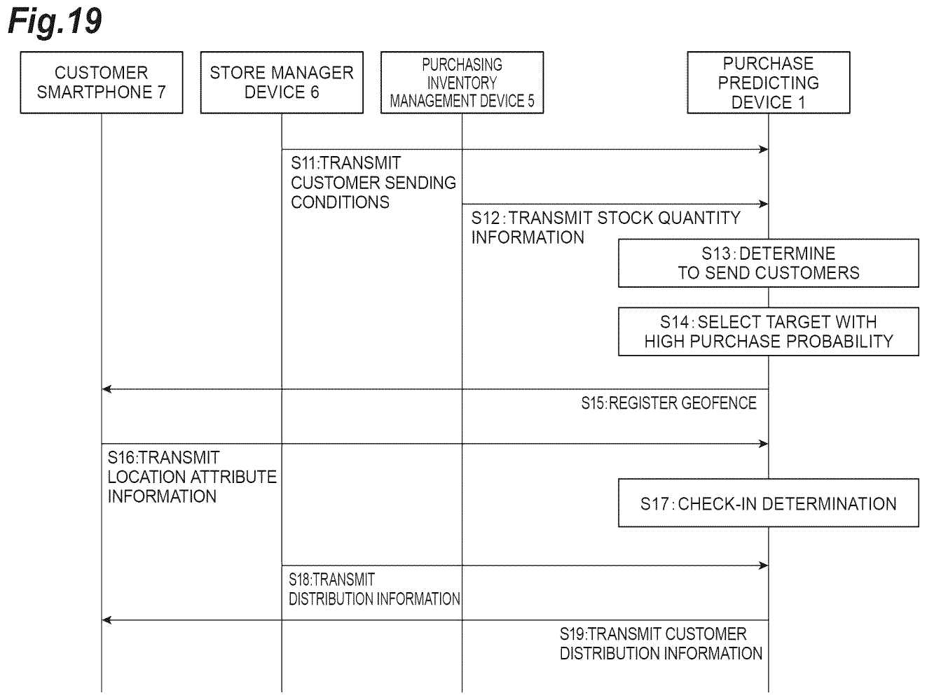

An example of the processing performed by the purchase prediction system 8 will be described with reference to FIGS. 18 and 19. FIG. 18 is a flowchart (part 1) showing an example of the processing performed by the purchase prediction system 8. FIG. 19 is a flowchart (part 2) showing an example of the processing performed by the purchase prediction system 8. The flowcharts in FIGS. 18 and 19 may be continuous. That is, the first processing (S11) in FIG. 19 may be performed subsequent to the last processing (S10) in FIG. 18.

In FIG. 18, first, the population distribution data acquisition device 2 transmits population distribution data to the purchase predicting device 1 (step S1). Then, the storage unit 10 of the purchase predicting device 1 stores the population distribution data transmitted in S1 (step S2). Then, the moving population data acquisition device 3 transmits moving population data to the purchase predicting device 1 (step S3). Then, the storage unit 10 of the purchase predicting device 1 stores the moving population data transmitted in S3 (step S4). Then, the external data acquisition device 4 transmits external data to the purchase predicting device 1 (step S5). Then, the storage unit 10 of the purchase predicting device 1 stores the external data transmitted in S5 (step S6). Then, the purchasing inventory management device 5 transmits purchase quantity data to the purchase predicting device 1 (step S7). Then, the learning unit 12 of the purchase predicting device 1 generates a prediction model (step S8). Then, the prediction unit 13 of the purchase predicting device 1 predicts the number of purchases (step S9). Then, the prediction unit 13 of the purchase predicting device 1 calculates a purchase probability (step S10).

In addition, in FIGS. 18, S1, S3, S5, and S7 may be in any order and may be executed multiple times, and each step of S1, S3, S5, and S7 may be repeatedly executed periodically. S2 may be executed at any time after S1 and before S8. S4 may be executed at any time after S3 and before S10. S6 may be executed at any time after S5 and before S8. The order of S9 and S10 may be reversed.

In FIG. 19, the store manager device 6 transmits customer sending conditions to the purchase predicting device 1 (step S11). Then, the purchasing inventory management device 5 transmits stock quantity information to the purchase predicting device 1 (step S12). Then, the customer sending unit 14 of the purchase predicting device 1 determines customer sending (step S13). In S13, it is determined to send customers. Then, the customer sending unit 14 of the purchase predicting device 1 selects a target with a high purchase probability (step S14). Then, the determination unit 15 of the purchase predicting device 1 registers a geofence for the customer smartphone 7 (step S15). Then, the customer smartphone 7 transmits location attribute information to the purchase predicting device 1 (step S16). Then, the determination unit 15 of the purchase predicting device 1 performs a check-in determination (step S17). Then, the store manager device 6 transmits distribution information to the purchase predicting device 1 (step S18). Then, the distribution unit 16 of the purchase predicting device 1 transmits customer distribution information to the customer smartphone 7 (step S19).

In addition, in FIG. 19, the order of S11 and S12 may be reversed. S18 may be executed at any time before S19.

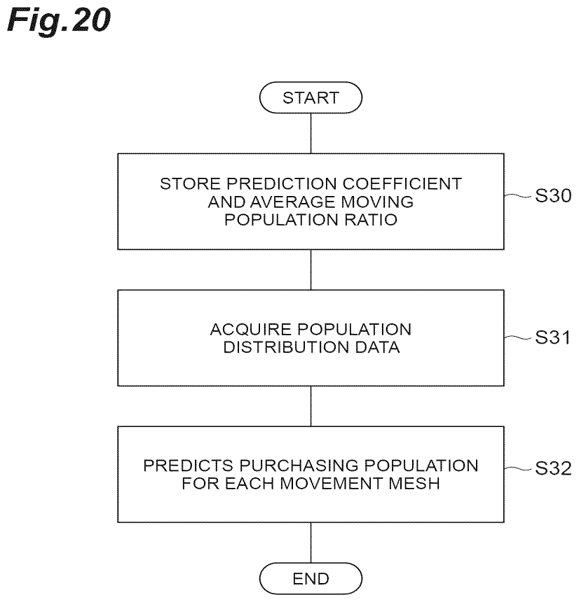

An example of the processing performed by the purchase predicting device 1 will be described with reference to FIG. 20. FIG. 20 is a flowchart showing an example of the processing performed by the purchase predicting device 1 according to the embodiment.

First, the storage unit 10 stores a prediction coefficient and an average moving population ratio (step S30, storage step). Then, the acquisition unit 11 acquires population distribution data (step S31, acquisition step). Then, the prediction unit 13 predicts a purchasing population for each movement mesh based on the population distribution data acquired in S31 and the prediction coefficient and the average moving population ratio stored in S30 (step S32).

Next, the effects of the purchase predicting device 1 according to the embodiment will be described.

According to the purchase predicting device 1, the storage unit 10 stores a prediction coefficient (action probability), which is a probability that a person in a predetermined mesh (area) will be involved in purchasing (actions), and an average moving population ratio (movement probability), which is a probability that a person in a predetermined mesh will move to a movement destination mesh that is a mesh of a movement destination. The acquisition unit 11 acquires population distribution data regarding the population for each mesh. The prediction unit 13 predicts a population involved in purchasing for each movement destination mesh based on the population distribution data acquired by the acquisition unit 11 and the prediction coefficient and the average moving population ratio stored in the storage unit 10. With this configuration, the population involved in actions for each movement destination mesh is predicted based on the population distribution data, the action probability, and the movement probability. That is, it is possible to predict the population involved in actions in each movement destination mesh.

In addition, in the purchase predicting device 1, the prediction coefficient may be a probability that a person in a predetermined mesh at a predetermined time will be involved in actions. The average moving population ratio may be a probability that a person in a predetermined mesh at a predetermined time will move to the movement destination mesh. The population of the population distribution data may be further determined for each time. With this configuration, it is possible to predict the population involved in actions for each time and each movement destination mesh. That is, more accurate predictions can be made, so that the usefulness of the prediction results increases.

In addition, in the purchase predicting device 1, the prediction coefficient may be a probability for each attribute of a person. The average moving population ratio may be a probability for each attribute of a person. The population of the population distribution data may be further determined for each attribute of a person. The prediction unit 13 may predict a population involved in purchasing for each movement destination mesh and each attribute of a person. With this configuration, it is possible to predict the population involved in purchasing for each movement destination mesh and each attribute of a person. That is, more accurate predictions can be made, so that the usefulness of the prediction results increases.

In addition, in the purchase predicting device 1, the prediction coefficient may be a probability for each weather. The acquisition unit 11 may further acquire weather data related to weather. The prediction unit 13 may make predictions further based on the weather data acquired by the acquisition unit 11. With this configuration, it is possible to reflect weather data in predictions. Therefore, since more accurate predictions can be made, the usefulness of the prediction results increases.

In addition, in the purchase predicting device 1, the prediction unit 13 may further predict a probability that a person will be involved in purchasing based on the predicted population involved in purchasing. With this configuration, since it is possible to predict a probability that a person will be involved in purchasing, the usefulness of the prediction results is increased.

In addition, the purchase predicting device I may further include the customer sending unit 14, the determination unit 15, and the distribution unit 16, which guide people based on the prediction result of the prediction unit 13. With this configuration, it is possible to appropriately guide people based on the prediction results.

In addition, in the purchase predicting device 1, the customer sending unit 14, the determination unit 15, and the distribution unit 16 may guide people in the movement destination mesh. With this configuration, since it is possible to guide people in the movement destination mesh, it is possible to more reliably guide people.

In addition, in the purchase predicting device 1, the action may be purchasing a product or service at a store, and the guide may be sending a customer to the store. With this configuration, for example, food loss can be reduced by sending customers to a store that has a large amount of food in stock close to its expiration date.

As described above, according to the purchase predicting device 1, it is possible to automatically send customers to stores.

In addition, the block diagrams used in the description of the above embodiment show blocks in functional units. These functional blocks (configuration units) are realized by any combination of at least one of hardware and software. In addition, a method of realizing each functional block is not particularly limited. That is, each functional block may be realized using one physically or logically coupled device, or may be realized by connecting two or more physically or logically separated devices directly or indirectly (for example, using a wired or wireless connection) and using the plurality of devices. Each functional block may be realized by combining the above-described one device or the above-described plurality of devices with software.

Functions include determining, judging, calculating, computing, processing, deriving, investigating, searching, ascertaining, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, and the like, but are not limited thereto. For example, a functional block (configuration unit) that makes the transmission work is called a transmitting unit or a transmitter. In any case, as described above, the implementation method is not particularly limited.

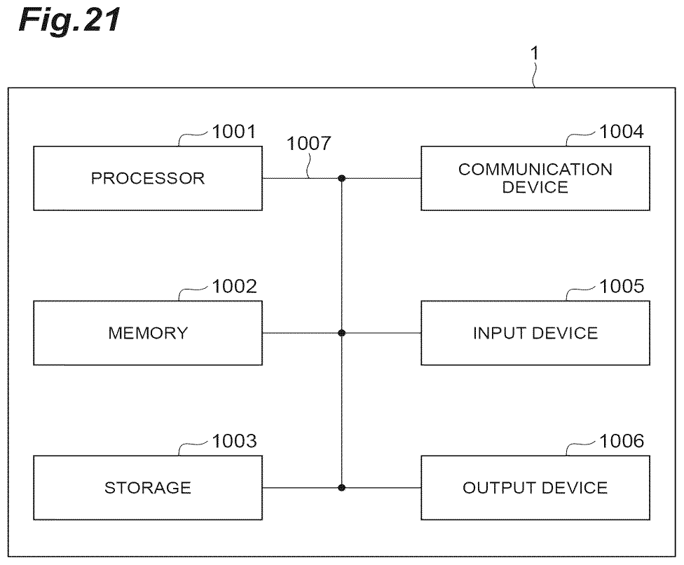

For example, the purchase predicting device 1 and the like according to an embodiment of the present disclosure may function as a computer that performs processing of the purchase prediction method of the present disclosure. FIG. 21 is a diagram showing an example of the hardware configuration of the purchase predicting device 1 according to an embodiment of the present disclosure. The purchase predicting device 1 described above may be physically configured as a computer device including a processor 1001, a memory 1002, a storage 1003, a communication device 1004, an input device 1005, an output device 1006, a bus 1007, and the like.

In addition, in the following description, the term “device” can be read as a circuit, a device, a unit, and the like. The hardware configuration of the purchase predicting device 1 may include one or more devices for each device shown in the diagram, or may not include some devices.

Each function in the purchase predicting device 1 is realized by reading predetermined software (program) onto hardware, such as the processor 1001 and the memory 1002, so that the processor 1001 performs an operation and controlling communication by the communication device 1004 or controlling at least one of reading and writing of data in the memory 1002 and the storage 1003.

The processor 1001 controls the entire computer by operating an operating system, for example. The processor 1001 may be configured by a central processing unit (CPU) including an interface with a peripheral device, a control device, an operation device, a register, and the like. For example, the above-described acquisition unit 11, learning unit 12, prediction unit 13, customer sending unit 14, determination unit 15, distribution unit 16, and the like may be realized by the processor 1001.

In addition, the processor 1001 reads a program (program code), a software module, data, and the like into the memory 1002 from at least one of the storage 1003 and the communication device 1004, and executes various kinds of processing according to these. As the program, a program causing a computer to execute at least a part of the operation described in the above embodiment is used. For example, the acquisition unit 11, the learning unit 12, the prediction unit 13, the customer sending unit 14, the determination unit 15, and the distribution unit 16 may be realized by a control program stored in the memory 1002 and operating in the processor 1001, or may be realized similarly for other functional blocks. Although it has been described that the various kinds of processes described above are performed by one processor 1001, the various kinds of processes described above may be performed simultaneously or sequentially by two or more processors 1001. The processor 1001 may be realized by one or more chips. In addition, the program may be transmitted from a network through a telecommunication line.

The memory 1002 is a computer-readable recording medium, and may be configured by at least one of, for example, a ROM (Read Only Memory), an EPROM (Erasable Programmable ROM), an EEPROM (Electrically Erasable Programmable ROM), and a RAM (Random Access Memory). The memory 1002 may be called a register, a cache, a main memory (main storage device), and the like. The memory 1002 can store a program (program code), a software module, and the like that can be executed to implement the radio communication method according to an embodiment of the present disclosure.

The storage 1003 is a computer-readable recording medium, and may be configured by at least one of, for example, an optical disk such as a CD-ROM (Compact Disc ROM), a hard disk drive, a flexible disk, and a magneto-optical disk (for example, a compact disk, a digital versatile disk, and a Blu-ray (registered trademark) disk), a smart card, a flash memory (for example, a card, a stick, and a key drive), a floppy (registered trademark) disk, and a magnetic strip. The storage 1003 may be called an auxiliary storage device. The storage medium described above may be, for example, a database including at least one of the memory 1002 and the storage 1003, a server, or other appropriate media.

The communication device 1004 is hardware (transmitting and receiving device) for performing communication between computers through at least one of a wired network and a radio network, and is also referred to as, for example, a network device, a network controller, a network card, and a communication module. The communication device 1004 may include, for example, a high-frequency switch, a duplexer, a filter, a frequency synthesizer, and the like in order to realize at least one of frequency division duplex (FDD) and time division duplex (TDD), for example. For example, the above-described acquisition unit 11, learning unit 12, prediction unit 13, customer sending unit 14, determination unit 15, distribution unit 16, and the like may be realized by the communication device 1004.

The input device 1005 is an input device (for example, a keyboard, a mouse, a microphone, a switch, a button, and a sensor) for receiving an input from the outside. The output device 1006 is an output device (for example, a display, a speaker, and an LED lamp) that performs output to the outside. In addition, the input device 1005 and the output device 1006 may be integrated (for example, a touch panel).

In addition, respective devices, such as the processor 1001 and the memory 1002, are connected to each other by the bus 1007 for communicating information. The bus 1007 may be configured using a single bus, or may be configured using a different bus for each device.

In addition, the purchase predicting device 1 may include hardware, such as a microprocessor, a digital signal processor (DSP), an ASIC (Application Specific Integrated Circuit), a PLD (Programmable Logic Device), and an FPGA (Field Programmable Gate Array), and some or all of the functional blocks may be realized by the hardware. For example, the processor 1001 may be realized by using at least one of these hardware components.

The notification of information is not limited to the aspects/embodiments described in the present disclosure, and may be performed using other methods.

Each aspect/embodiment described in the present disclosure may be applied to at least one of systems, which use LTE (Long Term Evolution), LTE-A (LTE-Advanced), SUPER 3G, IMT-Advanced, 4G (4th generation mobile communication system), 5G (5th generation mobile communication system), FRA (Future Radio Access), and NR (new Radio), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other appropriate systems, and next-generation systems extended based on these. In addition, a plurality of systems may be combined (for example, a combination of 5G and at least one of LTE and LTE-A) to be applied.

In the processing procedure, sequence, flowchart, and the like in each aspect/embodiment described in this disclosure, the order may be changed as long as there is no contradiction. For example, for the methods described in the present disclosure, elements of various steps are presented using an exemplary order. However, the present invention is not limited to the specific order presented.

Information and the like can be output from a higher layer (or a lower layer) to a lower layer (or a higher layer). Information and the like may be input and output through a plurality of network nodes.

The information and the like that are input and output may be stored in a specific place (for example, a memory) or may be managed using a management table. The information and the like that are input and output can be overwritten, updated, or added. The information and the like that are output may be deleted. The information and the like that are input may be transmitted to other devices.

The determination may be performed based on a value (0 or 1) expressed by 1 bit, may be performed based on the Boolean value (Boolean: true or false), or may be performed by numerical value comparison (for example, comparison with a predetermined value).

Each aspect/embodiment described in the present disclosure may be used alone, may be used in combination, or may be switched and used according to execution. In addition, the notification of predetermined information (for example, notification of “X”) is not limited to being explicitly performed, and may be performed implicitly (for example, without the notification of the predetermined information).

While the present disclosure has been described in detail, it is apparent to those skilled in the art that the present disclosure is not limited to the embodiments described in the present disclosure. The present disclosure can be realized as modified and changed aspects without departing from the spirit and scope of the present disclosure defined by the description of the claims. Therefore, the description of the present disclosure is intended for illustrative purposes, and has no restrictive meaning to the present disclosure.

Software, regardless of whether this is called software, firmware, middleware, microcode, a hardware description language, or any other name, should be interpreted broadly to mean instructions, instruction sets, codes, code segments, program codes, programs, subprograms, software modules, applications, software applications, software packages, routines, subroutines, objects, executable files, execution threads, procedures, functions, and the like.

In addition, software, instructions, information, and the like may be transmitted and received through a transmission medium. For example, when software is transmitted from a website, a server, or other remote sources using at least one of the wired technology (coaxial cable, optical fiber cable, twisted pair, digital subscriber line (DSL), and the like) and the wireless technology (infrared, microwave, and the like), at least one of the wired technology and the wireless technology is included within the definition of the transmission medium.

The information, signals, and the like described in the present disclosure may be expressed using any of a variety of different technologies. For example, data, instructions, commands, information, signals, bits, symbols, and chips that can be referred to throughout the above description may be represented by voltage, current, electromagnetic waves, magnetic field or magnetic particles, light field or photon, or any combination thereof.

In addition, the terms described in this disclosure and the terms necessary for understanding this disclosure may be replaced with terms having the same or similar meaning.

The terms “system” and “network” used in the present disclosure are used interchangeably.

In addition, the information, parameters, and the like described

in the present disclosure may be expressed using an absolute value, may be expressed using a relative value from a predetermined value, or may be expressed using another corresponding information.

The names used for the parameters described above are not limiting names in any way. In addition, equations and the like using these parameters may be different from those explicitly disclosed in the present disclosure.

The term “determining” used in the present disclosure may involve a wide variety of operations. For example, “determining” can include considering judging, calculating, computing, processing, deriving, investigating, looking up (search, inquiry) (for example, looking up in a table, database, or another data structure), and ascertaining as “determining”. In addition, “determining” can include considering receiving (for example, receiving information), transmitting (for example, transmitting information), input, output, and accessing (for example, accessing data in a memory) as “determining”. In addition, “determining” can include considering resolving, selecting, choosing, establishing, comparing, and the like as “determining”. That is, “determining” can include considering any operation as “determining”. In addition, “determining” may be read as “assuming”, “expecting”, “considering”, and the like.

The terms “connected” and “coupled” or variations thereof mean any direct or indirect connection or coupling between two or more elements, and can include a case where one or more intermediate elements are present between two elements “connected” or “coupled” to each other. The coupling or connection between elements may be physical, logical, or a combination thereof. For example, “connection” may be read as “access”. When used in the present disclosure, two elements can be considered to be “connected” or “coupled” to each other using at least one of one or more wires, cables, and printed electrical connections and using some non-limiting and non-inclusive examples, such as electromagnetic energy having wavelengths in a radio frequency domain, a microwave domain, and a light (both visible and invisible) domain.

The description “based on” used in the present disclosure does not mean “based only on” unless otherwise specified. In other words, the description “based on” means both “based only on” and “based at least on”.

Any reference to elements using designations such as “first” and “second” used in the present disclosure does not generally limit the quantity or order of the elements. These designations can be used in the present disclosure as a convenient method for distinguishing between two or more elements. Therefore, references to first and second elements do not mean that only two elements can be adopted or that the first element should precede the second element in any way.

“Means” in the configuration of each device described above may be replaced with “unit”, “circuit”, “device”, and the like.

When “include”, “including”, and variations thereof are used in the present disclosure, these terms are intended to be inclusive similarly to the term “comprising”. In addition, the term “or” used in the present disclosure is intended not to be an exclusive-OR.

In the present disclosure, when articles, for example, a, an, and

the in English, are added by translation, the present disclosure may include that nouns subsequent to these articles are plural.

In the present disclosure, the expression “A and B are different” may mean “A and B are different from each other”. In addition, the expression may mean that “A and B each are different from C”. Terms such as “separated”, “coupled” may be interpreted similarly to “different”.

### REFERENCE SIGNS LIST

1: purchase predicting device, 2: population distribution data acquisition device, 3: moving population data acquisition device, 4: external data acquisition device, 5: purchasing inventory management device, 6: store manager device, 7: customer smartphone, 8: purchase prediction system, 10: storage unit, 11: acquisition unit, 12: learning unit, 13: prediction unit, 14: customer sending unit, 15: determination unit, 16: distribution unit, 1001: processor, 1002: memory, 1003: storage, 1004: communication device, 1005: input device, 1006: output device, 1007: bus.

1. An action predicting device, comprising processing circuitry configured to:
store an action probability, which is a probability that a person in a predetermined area is going to be involved in actions, and a movement probability, which is a probability that a person in a predetermined area is going to move to a movement destination area that is an area of a movement destination;
acquire population distribution data regarding a population for each area; and
predict a population involved in actions for each movement destination area based on the acquired population distribution data, the stored action probability and the stored movement probability.

2. The action predicting device according to claim 1,
wherein the action probability is a probability that a person in a predetermined area at a predetermined time is going to be involved in actions,
the movement probability is a probability that a person in a predetermined area at a predetermined time is going to move to the movement destination area, and
the population of the population distribution data is further determined for each time.

3. The action predicting device according to claim 1,
wherein the action probability is a probability for each attribute of a person,
the movement probability is a probability for each attribute of a person,
the population of the population distribution data is further determined for each attribute of a person, and
the processing circuitry is configured to predict a population involved in actions for each movement destination area and each attribute of a person.

4. The action predicting device according to claim 1,
wherein the action probability is a probability for each weather,
the processing circuitry is further configured to acquire weather data related to weather, and
the processing circuitry is configured to make predictions further based on the acquired weather data.

5. The action predicting device according to claim 1,
wherein the processing circuitry is further configured to predict a probability that a person is going to be involved in actions based on the predicted population involved in actions.

6. The action predicting device according to claim 1,
wherein the processing circuitry is further configured to guide a person based on a prediction result.

7. The action predicting device according to claim 6,
wherein the processing circuitry is configured to guide a person in the movement destination area.

8. The action predicting device according to claim 6,
wherein the action is purchasing a product or service at a store, and
the guide is sending a customer to the store.

9. The action predicting device according to claim 2,
wherein the action probability is a probability for each attribute of a person,
the movement probability is a probability for each attribute of a person,
the population of the population distribution data is further determined for each attribute of a person, and
the processing circuitry is configured to predict a population involved in actions for each movement destination area and each attribute of a person.
